(19) United States
(12) Patent Application Publication
(10) Pub. No.: US 2009/0242860 A1
(43) Pub. Date: Oct. 1, 2009

(54) CABLE INSTALLATION

(76) Inventors: Philip A. Barker, Ipswich (GB); Nitzan Gonen, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 12/295,778

(22) PCT Filed: Apr. 2, 2007
(86) PCT No.: PCT/GB2007/001178

§ 371 Date: Oct. 2, 2008

(30) Foreign Application Priority Data
Apr. 3, 2006 (EP) 06251883.2

(51) Int. Cl. H02G 1/08

(52) U.S. Cl. 254/134.4

(57) ABSTRACT

A method of installing a cable into a conduit, the conduit having more than one bore size, comprising the steps of—introducing air to flow in a direction into and through the conduit, and—changing an air pressure level of the air within the conduit from a first pressure level to a second pressure level by either venting a part of the air from the conduit or adding to the air within the conduit.

The present invention relates to methods and apparatus relating to the installation of cables, in particular by the technique known in the art as “blown fibre”. More specifically, but not exclusively, the present invention relates to the installation of optical fibre into conduit tubes of differing internal dimensions.

The technique of blown fibre is described in e.g. EP108590, and the methods, plant and equipment and advantages of the technique are well known. In brief, instead of installing an optical fibre cable along a route between two points to be connected, an empty conduit duct or tube is initially installed along the route. If and when it is decided that the two points are to be connected, an optical fibre unit is installed through the tube. This is done by using the effects of viscous drag along the surface of a fibre unit obtained by the feeding of compressed air into the conduit tube. As described in EP108590, viscous drag is a complex force determined by various factors, including the velocity of air within the tube, and air pressure, mass and volume. The present description shall refer mainly to air velocity and mass as determinants of the level of viscous drag although the others should be borne in mind.

The term “fibre unit” (being a number of optical fibres in a bundle) in this description is used interchangeably with “optical fibre” or “fibre” (a single optical fibre), “fibre cable” (being fibre(s) encased within one or more jackets) and so on, as the context permits.

With this method, “just in time” deployment can be achieved, and installation costs deferred to the stage only when it is certain that the two points are to be connected. Another advantage is flexibility in network planning and designing, and the possibility of taking on board the latest fibre technology at the later stage when it is decided to populate the tube, such as the enhanced performance fibre unit (EPFU) described in EP521710, which is a lightweight, flexible fibre unit.

The installation process involves the fibre unit being transported through the tube by a combination of mechanical driving means, and the effects of viscous drag of compressed air which is being fed down the tube at the same time. The mechanical driving means are typically provided in a motorised device known as a “blowing head”, which includes drive wheels which propel the fibre unit through the tube. The drive wheels help to overcome the resistive forces experienced within the tube, so that the fibre unit can (continue to) be driven into and through the tube whenever it is not being pulled along by the viscous drag on of the air within the tube. The compressed air is supplied by an air compressor and is directed by the blowing head into the tube, which ensures that air and fibre are blown into the same tube.

Blown fibre technology was first developed and adopted in the UK in the 1980s by the applicants for use in the telecommunications network. Fibre tube technology has developed since then, so that the network infrastructure now includes legacy tubes comprising different materials (e.g. different liners within the tubes), configurations and sizes. In particular, tubes could have different inner or internal diameter bore sizes. In general, bore sizes have reduced over time: as an example in the UK, the early fibre tubes laid down in the network had bore sizes of 6 mm and an external diameter of 8 mm. Following concerns that the blown fibre tubes were occupying too much space, tube bore sizes were in the mid-1990s reduced to 3.5 mm (external diameter 5 mm). As part of the push to FTTH, plans are currently underway to adopt even smaller tubes having an internal diameter of 2.5 mm and an external diameter of between 4 mm to 6 mm for aerial and other applications. This move allows for even greater fibre density in the tubes, improves the appearance of installation (especially, in the context of FTTH, in residential premises), can be used in compact joints, as well as for aerial installation where a smaller tube size reduces the amount of loading that must be withstood, in the form of wind and ice. A smaller tube is also more efficient as less air required for the installation, which reduces the power, size, output requirements and operational costs associated with powerful air compressors.

A fibre conduit route between points may therefore comprise two or more tubes with dissimilar-sized bores connectorised together using a connector so that the bores of the tubes communicate with each other via the bore of the connector e.g. within a joint box or a tube flexibility point. The connector can be a reducer connector (which accommodates two tubes having different outer diameters as is the case with the fibre tubes used in the UK), or a straight connector (where even though the internal bore diameters are dissimilar, the outer diameters are the same).

The principle underlying blown fibre technology is that when air travels within the tube at a greater velocity than the fibre unit, the friction generated on the skin of the fibre unit can be sufficient to pull the fibre unit along on a bed of air. Naturally, if the air flow slows down, or stops, the viscous drag along the surface of the fibre unit is reduced, which can result in problems with the installation.

The level of viscous friction drag experienced on the skin of the fibre unit is related to the velocity at which the air is travelling. Thus, if air velocity or pressure reduces within the conduit, the effects of viscous drag are also reduced on the fibre unit. When the fibre unit cannot be dragged along by the air, the current method is to allow the mechanical driving force of the blowing head to take over at least in part to propel the fibre unit along the conduit. However, the fibre unit (especially EPFU) is a flexible and relatively fragile cable, and susceptible to buckling if pushed excessively by the blowing head at the head end, e.g. if it is caught somewhere within the tube—this may adversely affect its performance after installation. In the worst case, the fibre unit could suffer mechanical strains or break. It is thus preferable to have the fibre unit pulled along on a bed of air by viscous drag whenever possible.

As noted above, a certain minimum threshold of air velocity and mass is thus required to generate sufficient viscous drag for effective blown fibre installation. Various apparatus to overcome the problem of unequal air velocity along the conduit tube are known. For example, it is known from EP901593 to use a number of deliberately leaky connectors to connect a number of fibre tubes in a series. The non-linear air pressure gradient is thus somewhat flattened, so the fibre unit can be installed without the need for a separate mechanical pushing force. It is to be noted that this invention is directed to the problem of improving viscous drag only (without the need for a separate mechanical driving force) to install an optical fibre in a conduit having the same bore size throughout its length only, the conduit comprising a number of tubes connected in a series using a number of connectors. It does not address the problems associated with installing a blown fibre through a conduit having dissimilar bores along its length. In EP318280 there is a description of the use of a venturi effect to encourage the flow of air along the conduit. Again this does not address the issues of blowing a fibre unit though a conduit with dissimilar bore sizes.

In a tube having a bore of substantially uniform size throughout its length, when compressed air fed into a tube from one end, the pressure gradient set up along its length typically shows pressure levels to be highest at the head end (where the air is fed into the conduit). The air decompresses as it flows along the conduit so that pressure levels reduce as the distance from the head end increases, gradually to reach atmospheric levels at the far, or remote end. Correspondingly, air initially moves at a relatively slow velocity along the conduit when it is first fed into the tube at the head end, which velocity gradually increases as expansion occurs further into the tube.

Air flow is affected by the length of the tube. Air flow rates measured at the remote end of the tube are lower in longer tubes compared to shorter ones. This is because a higher level of resistance is created within longer tubes than shorter ones, and less air enters the tube at the head end.

Air flow rates are also dependant upon the cross sectional area (CSA) of the tube. The CSA value is related to the volume of the tubes. A fibre tube having a 6 mm bore has a CSA of 28.28 mm², that for a bore size of 3.5 mm is 9.62 mm², and that of 2.5 mm bore size is 4.91 mm². In a composite conduit, two tubes having such significantly different bore sizes are connected so that the transition point where bore sizes and CSAs change, smooth air flow and fibre installation is disrupted.

Under certain very limited circumstances—e.g. where both tube lengths are very short—it may be possible to install the fibre unit through the composite route by blowing from one end to the other via the connector. However the conditions need to be optimal, and such an unpredictable practice cannot be deployed in the field where there are too many variables to control.

As an alternative to the above, a commonly-used, more fail-proof method is to install the blown fibre using a technique known variously as “centre blowing”, “mid-point blowing”, “bidirectional installation” or the like. In this method, the installation is performed at an intermediate point along the composite route, at the point of the bore size change. It essentially involves two installations, where the operator installs each end of the fibre unit into each tube in opposite directions. As such this method involves more work, time and expense than for a single unidirectional, end-to-end installation starting at one end of the composite conduit and ending at the far, or remote end. This is especially the case where one section of the conduit is relatively short (e.g. about 30% of the total length) so that a separate installation to populate that section of the conduit is relatively wasteful of resources. Due to the high risk of failure otherwise, however, it is often preferred to play it safe.

The problems experienced in the installation of blown fibre across fibre tubes having different bore sizes are different, depending on whether the fibre unit is to be installed from the tube with the larger bore to the smaller bore, or the other way around.

In the first scenario, air is fed into the tube with the larger bore with the intention that the air flows into and through the tube with the smaller bore size. At the transition point, air from the larger bore is hindered from entering the smaller tube with its smaller CSA. As a result, air pressure at the junction builds up as the smaller bore is effectively acting as a flow restrictor. Air velocity drops, with the result that the friction acting on the fibre surface to drag the fibre through the larger tube is reduced. Fibre installation is either delayed or stopped, and fibre buckle at this point is common.

In the second case where air is fed into the tube with the smaller bore with the intention that the air flows into and through the tube with the larger bore size, the problem is the reverse. As the larger bore has a considerably larger CSA, the same mass of air travelling within the smaller bore is insufficient to fill the larger bore with the larger CSA and consequently cannot generate viscous drag on the skin of the fibre unit. This is so even though the speed in the smaller tube remains unchanged or increases, as the problem now is that there is an insufficient amount of air to act on the surface of the fibre unit. Once again fibre installation is either delayed or stopped.

With the advent of fibre to the home or premises (FTTH/FTTP), the conduits will eventually extend to residential premises and at even greater levels to commercial and industrial premises. Indeed it is a fundamental part of the push to FTTH in the UK that substantially all the network will comprise optical fibre, extending from the core network to as many end customers as possible. To achieve the critical mass of public acceptance and demand, optical fibre installation—of which the current invention is a part—needs to be a velocity, cost- and effort-efficient proposition.

It is therefore desirable to address the problems described above.

According to a first aspect of the invention, there is provided a method of installing a cable into a conduit, the conduit having more than one bore size, comprising the steps of
introducing air to flow in a direction into and through the conduit, and
changing an air pressure level of the air within the conduit from a first pressure level to a second pressure level by either venting a part of the air from the conduit or adding to the air within the conduit.

Within the context of blown fibre installations in particular, this method of the invention is aimed to reduce the effect of a change in bore size part way though a composite conduit which change could be a gradual tapering change, or a step change. By venting or adding air e.g. via an aperture in the conduit, air pressure can be adjusted to a desired level within the conduit, particularly at the section or point where the venting or adding is performed. Targeting venting or adding activity at specific points along the conduit e.g. at or near the transition point where the different bore sizes interface each other has the greatest effect and is thus particularly advantageous. Once the desired pressure level is obtained, this is preferably maintained for the remaining duration of the session.

Where the bore size decreases along the direction of the air flow, air is vented from the conduit. This is preferably done at or near a transition point which could be an obvious point where the bore size change is a step change; alternatively air could be vented from the larger bore but superior results are obtained when the vent point is proximate to the transition point; venting from the larger bore at a point too far from the transition point may result in the creation of a “dead spot” (where air is not flowing adequately) after the vent point along the conduit.

Where the bore size increases in the direction of the air flow, air is added to the conduit. Again, this is performed preferably at a point at or near the transition point; air could also be added into the smaller bore, although performing this step near the transition point may help avoid the creation of a dead spot within the small tube between the transition point and the adding point.

Preferably, the desired pressure level is obtained by use of conventional apparatus such as air pressure maintaining gauges, air pressure valves, or flow meters.

The conduit could comprise more than one change of bore size, so it would be possible to use the method of the invention to vent and add air as required along the length of the conduit.

According to a second aspect of the invention, there is provided a method of installing a cable into a conduit using a flow of air, the conduit comprising a first tube having an outlet end and a second tube having an inlet end, the first tube having a larger bore size than the second tube,

wherein the outlet end is associated with an outlet air pressure level above which air cannot flow from the outlet, and the inlet end is associated with an inlet air pressure level below which air cannot enter the inlet,
the method comprising the steps of
connecting the outlet end and the inlet end to form a transition point,
introducing air into the first tube to flow to the outlet end,
changing a transition air pressure level of the air at or near the transition point so that the transition air pressure level is a level between the outlet air pressure level and the inlet air pressure level by venting a part of the air from the conduit.

This aspect of the invention is for use in a set up where the conduit comprises two tubes having are connected together at a transition point, so that air is fed into the tube with the larger bore with the intention that it flow into and through the tube with the smaller bore. Air cannot flow from the outlet of the first tube if the pressure level beyond the outlet exceeds a certain pressure level. Air cannot flow into the inlet of the second tube if the air seeking to enter is below a certain pressure level. This aspect of the invention solves the problem by adjusting the air pressure level between the two bore sizes so that it is below the outlet pressure level and above the inlet pressure level. The adjustment is achieved by venting air from the conduit at or near the transition point. In a preferred implementation of the method, the desired pressure level, or range of desired pressure levels, are pre-determined for use e.g. by consulting a table of known values, by use of a mathematical formula (which result can be obtained by manual calculation or by an electronic calculator or microprocessor), or by determining the level(s) just prior to the installation itself.

According to a third aspect of the invention, there is provided a connector for installing a cable into a conduit, the conduit comprising a first tube having a first bore size, connected by the connector to a second tube having a second bore size, wherein the first bore size differs from the second bore size,

and wherein in use, air is introduced into the first tube to flow through the first tube to the second tube via the connector,
the connector comprising
connection means to form the conduit by connecting the first tube to the second tube, and
means to change an air pressure of the air within the conduit from a first pressure level to a second pressure level by either venting a part of the air from the conduit or adding to the air within the conduit.

Using such a connector allows for a conduit to be formed between the large bored tube and the smaller bored tube, as well as for the control of air pressure at or near the transition point by venting and adding of air at or near the transition point preferably by an aperture. The device can include means to maintain the desired pressure level within the connector, which means can be integral to the device e.g. in the form of an adjustable aperture, and/or separate thereto e.g. in the form of a pressure maintaining gauge. In the latter case, the device is adapted to work with such external device, e.g. by being configured to be connected by hoses or the like.

The device can be dedicated to only venting, or only adding, or it could be adapted for both purposes. The same aperture could be used for both purposes, or else different apertures could be provided in the device for different functions.

According to a further aspect of the invention, there is provided an installation for installing a cable into a conduit, the conduit including a first tube having a first bore size, and a second tube having a second bore size, wherein the first bore size differs from the second bore size, the installation comprising

an air source to introduce air to flow into and through the conduit, and
a connector according to claim 17.

In a blown fibre installation, use of the connector advantageously allows for air fed into the head end to flow at a more constant rate through the conduit which bore size changes part way through. Such an air flow can be better harnessed for installing a fibre unit though the conduit using viscous drag.

Systems, methods and apparatus embodying the present invention will now be described by way of example only, with reference to the following drawings, wherein:

FIG. 1 is a view of a reducer connector according to the prior art;

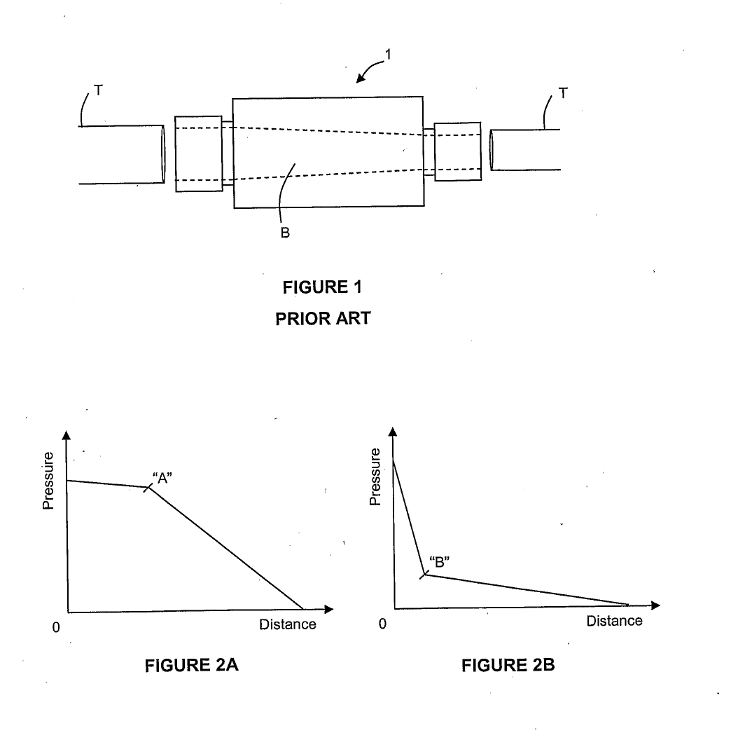

FIGS. 2A and 2B are graphs depicting typical pressure gradients in dissimilar bore blown fibre installations;

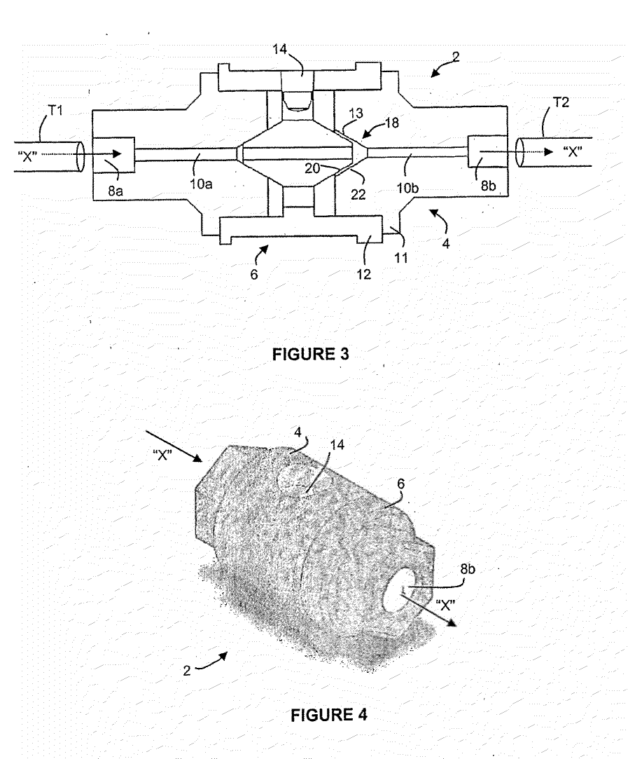

FIG. 3 is a cross sectional view of a connector of the invention for large bore to small bore installation;

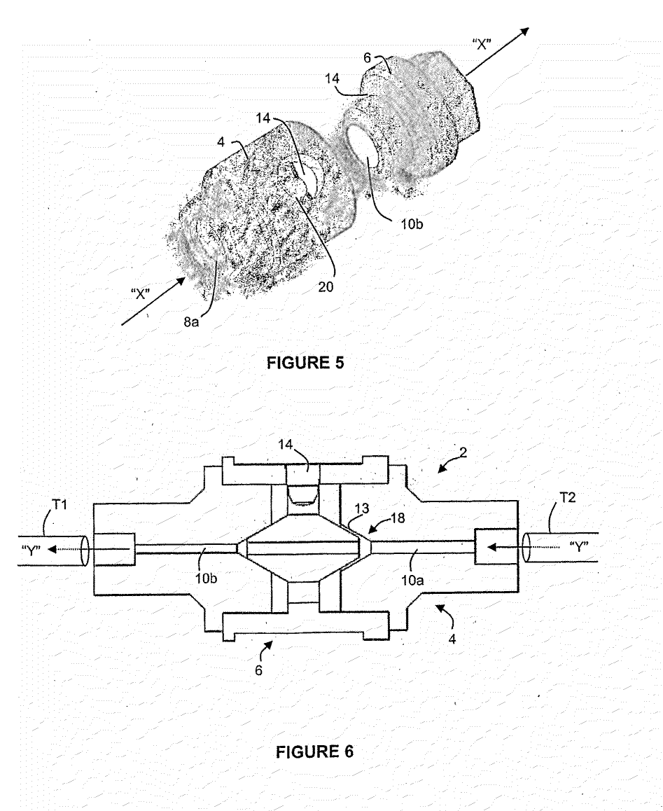

FIGS. 4 and 5 are external views of a connector;

FIG. 6 is a cross sectional view of a connector of the invention for small bore to large bore installation; and

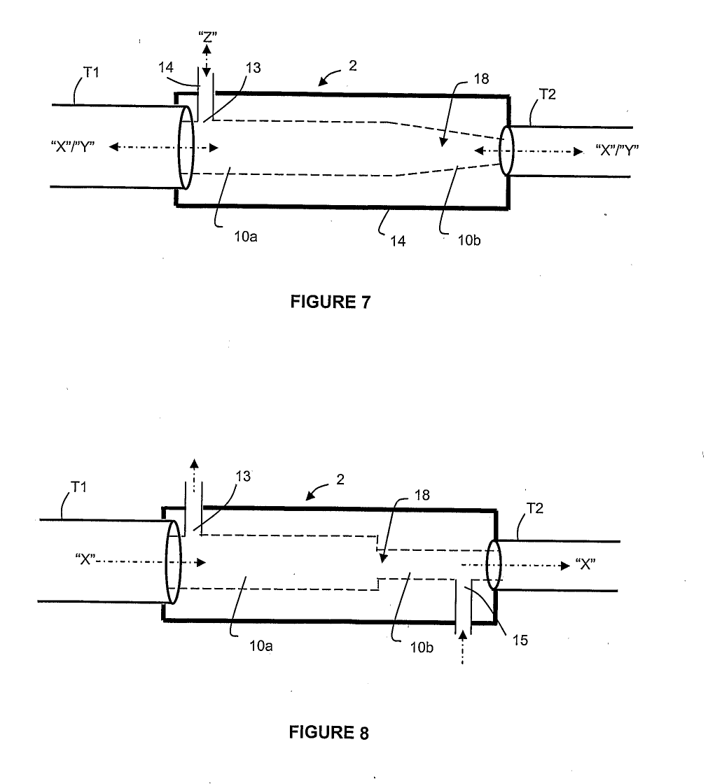

FIGS. 7 and 8 are views of connectors being other embodiments of the invention.

As briefly referred above, the problems faced by network operators wishing to populate pre-laid conduit tubes with fibre, where the tube route includes a bore size change part way through, can be classed into two types. The first are those when it is desired to install blown fibre by feeding air into the tube route from the larger tube to the smaller tube, and the second is when air is fed from the smaller tube to the larger tube.

For ease of reference, “large tube” or “larger tube” will refer a tube with a large or larger inner bore diameter, and “small tube” or “smaller tube” will correspondingly refer to a tube with a small or smaller bore size. Where the context permits, reference to e.g. “larger tube” may also refer to the bore of that tube. The skilled person would be aware that it is possible for two tubes to have identical outer diameters but different internal bore dimensions: the invention here is primarily concerned with the internal bore sizes of tubes.

The skilled person would also understand that the bore size change within the conduit need not be a step change or changes, but could also be a gradual change so that the bore steadily narrows or broadens along its length. Of course, the conduit could comprise a combination of step and gradual change(s). In such a gradual-change case, there is no specific “transition point” along the conduit. The references to bore size changes, “small-to-large” and “large-to-small” installations should be construed accordingly.

FIG. 1 shows a prior art “reducer” connector (1) currently used in a typical composite conduit, in the form of a reducer connector to join two tubes (T) with dissimilar bores. The connector is substantially cylindrical, and accommodates the outlet end of one tube, and the inlet end of the second tube, usually in the form of a friction fit. Which is the “outlet” and which the “inlet” would depend on the direction of the intended installation, so in a large-to-small blowing for example, the larger tube provides the outlet end and the smaller tube the inlet end. The inner profile of the reducer comprises a bore (B) extending through the length of the housing, which tapers between the respective sizes of the tubes received at each end. As, can be seen, the bore (B) prior art connector is open only at the two ends receiving the tube ends.

### Larger-Tube to Smaller-Tube Blown Fibre Installation

As described above, in a composite conduit comprising a larger tube connectorised to a smaller tube, the smaller tube acts as a flow restrictor when air is fed through from the head end. Air builds up in the transition point between the two tube bore sizes. As a result, air flow slows in the larger tube proximate to its outlet end and in an extreme case might come to a complete stop. Fibre buckling can occur at this stage. In order to obtain the continued flow of air in the larger tube, a method according to the invention provides for a vent in the conduit to allow “excess air” to be removed from the bore. As the excess air passes from the conduit to the surrounding environment or atmosphere, the air pressure levels within the larger tube are reduced, and air flow into the transition point from the larger tube improved.

To obtain the flow of air across the transition point into the small tube however, there must be a sufficient pressure level of air acting on the inlet end of the small tube. The air in the larger tube thus cannot be vented in an uncontrolled manner to the atmosphere, even though this would be ideal for obtain air flow within the large tube. The precise pressure level depends on certain properties of the bigger tube as well as of the smaller tube at the transition point, including bore size and its length. Thus, pressure levels at the vented transition point cannot drop to below a certain minimum level, if the air is to flow across the transition point and into the small tube.

The above can be further understood with reference to a pressure gradient graph showing the typical profile of a large-to-small bore blown fibre installation as shown in FIG. 2A.

At the start of the installation at the head end of the conduit (where distance is 0), air is fed in at a certain pressure level. This level drops only slightly as distance increases from the head end, due to the pressure build up at the interface of the large and small bores. After the air crosses the transition point (represented by point “A” on the graph) and flows into the small tube, pressure rapidly drops as distance from the head end increases. The gradient along the small bore is steeper than that for the larger bore because the same level of head pressure would cause air to move faster along the small bore than for a larger bore. At the remote end, the air vents to the atmosphere, so pressure levels at the end of the conduit are at atmosphere (stated as 0 on the graph for convenience).

Ideally, the air fed into the conduit at the head end should flow at a good rate to generate the friction along the fibre surface necessary to propel it through the tube. This can be represented by a steep gradient on the gradient profile. It thus can be seen from the graph that the pressure build up from 0 to point “A” is reducing air flow within the larger tube. According to the invention therefore, the pressure level at the transition point is to be within a range of air pressure level values, the lower limit being that required to enable enough air to enter the smaller tube, and the upper limit defined by that beyond which insufficient air travels from the large tube into the transition point.

In the invention, a vent is provided in the conduit in order to increase the pressure differential across the conduit, and hence to increase the velocity and the mass of air travelling in the conduit. This is usually done at the transition point or a place proximate thereto.

The vent itself can at the most basic level, comprise one or more simple perforations or apertures provided in the tube(s) themselves, or which are made during the installation session. Alternatively, the natural gap between the outlet and inlet ends of the two tubes can serve as a vent. There are a variety of other devices such as needle valves which can provide a vent for present purposes. Preferably however, the vent is provided as part of a dedicated connecting device, which can be a T-piece, or a cylindrical tube connector, or the like. Use of such a connector has the advantage of serving the same purpose as a conventional reducer or straight tube connector after the installation, if the connector can be left in situ after the fibre has been blown through. Furthermore, if the connector is pre-configured, or adjustable and adjusted for the particular installation, it can be installed on within the composite conduit route, and may serve its purpose without the need for the operator to be present at the point where it is installed. An example of such a connector is discussed below in connection with FIGS. 2 to 5 below.

The venting need not be performed at the transition point itself, so the vent can be positioned at any point along the conduit that would have the effect of removing surplus air impeding flow into a smaller bore, e.g. within the large tube. However, a vent sited at or near the transition point would provide a more immediate and useful effect at the place within the conduit where air pressure buildup causes problems within the conduit.

The excess air can be vented in a number of ways, several of which will be discussed here. The simplest method would be for the operator to site himself at the location of the vent and to monitor the vent and conduit during an installation. When the operator observes that air is flowing into the small tube, this is an indication that sufficient excess air has vented from the tube. With the air flowing freely within the conduit, the likelihood is that sufficient air velocity and mass exists to generate the necessary viscous drag on the fibre unit. In performing this method, the operator can either allow the air to vent in an uncontrolled manner, or preferably control the venting flow from the vent to indirectly control pressure levels within the conduit. In a very basic implementation of this aspect of the invention, the operator could adjust the extent to which the venting aperture is covered by using his thumb, or the like. When the air flow is proceeding at a satisfactory pace, the operator can subsequently opt to maintain the pressure level (discussed below).

This method will work if the operator is experienced and has a good feel for the technique. This method does not require any data about ideal pressure levels within the tube, or any other information other than that the air is flowing freely across the large tube to the small tube across the transition point.

However in seeking a cost-effective method, it would be advantageous also to have a method not requiring so much skill or experience. This technique is also not necessarily accurate, and may not be repeatable.

A more precise method of removing excess air pressure can be obtained by using a device that measures the pressure levels at or around the vent, such as a pressure gauge. Alternatively, an air flow meter can be measured to indirectly monitor pressure. In this method, the operator preferably has some knowledge of what the pressure level within the conduit at the transition point should be. This information can be obtained as a step immediately prior to installation, or else pre-prepared and provided to the operator for use during installations.

The values relating to the ideal pressure levels at the transition point, can be obtained in the following manner. As noted above, the target pressure level is one within a range of air pressure level values, defined at the lower limit as being that required to enable a sufficient amount of air to enter the smaller tube, and at the upper limit as being that beyond which insufficient air travels through the large tube into the transition point. The pressure levels at the outlet end of the large tube and the inlet end of the smaller tube are thus the chief determinative factors. Other factors influencing air pressure levels without the conduit include the pressure level of the air fed in at the head end of the conduit, bore size, and tube length, as well as ambient temperatures, the type of liner in the tube, etc. With this knowledge, it is realistic to calculate, or to prepare a list or table of “typical” ideal pressure values that will cover most installation situations, within certain tolerances.

An example of some such ideal pressure values are as follows:

TABLE 1
Ideal pressure level values for dissimilar
bore blown fibre installation

2.5 mm

| 3.5 mm | 182 m | 370 m | 558 m | 746 m |
|---|---|---|---|---|
| 182 m | 5.5 bar | 5.0 bar | 4.5 bar | 3.5 bar |
| 370 m | 6.5 bar | 6.0 bar | 5.5 bar | 4.5 bar |
| 558 m | 8.0 bar | 7.5 bar | 7.0 bar | (not available) |

In the above table, two tubes having respectively 3.5 mm and 2.5 mm bores of a variety lengths have been connected together in different combinations. The preferred, or ideal pressure level to be attained at the transition point where the two bores intersect, are set out in the table. So, for example, where two lengths of dissimilar-sized bores of 182 m are connected to each other, the ideal pressure level at the transition point should be 5.5 bar. It should be noted that these figures can be used not only for large bore to small bore installation, but also for an installation in the opposite direction, from small bore to large bore (discussed below against FIGS. 5 and 6).

The skilled person would be able to develop e.g. a spline function from the above data, which can then be used during installation sessions to extrapolate or interpolate the ideal pressure level for a particular session given knowledge about the relative bore sizes and tube lengths used. It would be a simple matter to provide a simple electronic device using the function or other formula which can calculate the ideal pressure value for the operator's use.

Another method of obtaining the required pressure levels involves the following. First, an airflow restrictor is placed at the outlet end of the big tube. Air is fed down the large tube at the head end, and then the pressure at the far or outlet end of the large tube is measured. That provides the upper limit of the ideal transition point pressure range. A similar process is carried out with the small tube, except the far end of the small tube need not be restricted, and the measurement is taken at the head or inlet end. This gives the lower limit of the ideal pressure range. Thus can a list of the ranges (which could alternatively comprise single pressure values) be generated.

As mentioned above, these steps to obtain the ideal pressure ranges or values could also performed immediately before the start of the installation session itself, or for future consultation in e.g. a table. The inconvenience of carrying out this procedure for the particular installation session may in some cases be mitigated by the superior accuracy of the ideal pressure ranges or value. It may in any case be sometimes necessary to perform this where the tube set up is not typical, or where e.g. one or both tube lengths are not (accurately) known, so that the required data is not available in the pre-prepared literature.

Once it is known what the ideal pressure level should be, the operator can then use the vent to bleed off the excess air until the desired pressure level is reached, which the operator can learn from e.g. a pressure gauge connected to the conduit. In an alternative and preferred implementation, use of a pressure-maintaining valve will be able to perform the further preferred step of keeping the pressure level at an ideal level. If the device used is not itself capable of maintaining the pressure at the desired level, further or separate apparatus or steps can be employed, as discussed below.

When the ideal air pressure level has been reached at the transition point, the level can be maintained as a preferred further step. This can be achieved in a variety of ways. At the most basic, the operator could manually do so—e.g. if the vent comprises a single aperture which is sufficiently small, he could cover part of it with his thumb, or tape up a section of the vent, or the like.

In a preferred implementation, a pressure maintaining valve is used. In such a device, a specific value (e.g. the desired pressure value) is set and the valve accurately maintains the pressure within the conduit at that level.

In the absence of a pressure maintaining valve or the like, a vented connector can be used. Such a connector can be supplied to the operator with pre-configured vents which are intended for use in blown fibre installations having certain parameters (i.e. where the two tubes are of a certain length, have a certain bore size, etc.). The set of ideal pressure level figures can be used to configure vents in such connectors which will vent and preferably also maintain the ideal pressure level, once reached. In one design, the vent comprises one or more orifices leading out from the connector, which orifices are so narrow that once the ideal pressure level is reached, the air preferentially flows to the inlet of the small bore.

Alternatively, the connector is not pre-configured, but is adjustable by the operator to customise it for the particular installation. This is discussed further below.

Referring now to the drawings, FIG. 2 is a cross sectional view of a connector according to the invention, for use for large bore to small bore blown fibre installations.

It comprises a housing which in this embodiment consists of two portions, a first housing portion (4) and a second housing portion (6). The two portions are fitted together in this embodiment with coupling portion (11) on the first housing portion (4) which engages with the shoulder (12) of the second housing portion (6). The engagement of the housing portions can be a simple snap-fit, screw-fit, or the like. A throughbore (10) extends along the housing. The throughbore is formed when the two housing portions are coupled together, as the two connector bore sections (10a and 10b), are located in the respective housing portions. The connector bores are different in size: here, the one (10a) located in the first housing portion (4) is larger than the other one (10b) located in the second housing portion (6). At the extreme ends of the housing, the bore widens to form openings (8a and 8b) to accommodate a fibre conduit tube (T) at each end. In use, the fibre tubes are push-fit into each opening (8) or otherwise coupled to the ends of the connector, to form a continuous conduit extending from one tube bore to the other tube bore via the connector bore (10).

As noted above, the connector (2) is intended for use with fibre tubes (T) having different internal bore sizes. In the connector shown in FIG. 2, the larger tube (T1) is coupled to the connector at the larger opening (8a) leading to the larger connector bore (10a); the smaller tube (T2) is coupled to the other, smaller opening (8b) which leads to the smaller connector bore (10b). In one embodiment, the dimensions of the connector bores (10a, 10b) in each case can be similar to the bore sizes of the tubes (T1, T2).

The larger connector bore (10a) and the smaller connector bore (10b) interface at a transition point (18). An annular vent (13) communicates with the connector bore (10) also at the transition point (18), which leads from the transition point, through the housing of the connector, and out to the surrounding environment via a housing aperture (14).

The vent (13) is formed from a male frustum structure (20) located in the first housing portion, and a corresponding female frustum structure (22) located in the second housing portion. They are configured to substantially fit into each other when the housing portions are assembled, but which, even upon assembly, the two structures are separated by a continuous, annular gap (13). This gap serves as the vent. The vent extends from the connector bore (10) at an angle to the longitudinal axis of the connector bore, to the housing aperture (14).

In use, the two housing portions (4 and 6) are coupled together, and fibre tubes (T) connected to the openings (8), where the larger tube (T1) is connected to larger opening (8a) and the smaller tube (T2) is connected to smaller opening (8b). Compressed air is fed into the head end of the larger tube (T1) with the intention that the air flows in the direction “X” from the larger tube (T1) to and through the smaller tube (T2) to exit from the remote end of the smaller tube, via the connector bore (10) and the transition point (18). The fibre unit is also fed into the head end of the conduit using a blowing head or similar apparatus.

When the air flow reaches the transition point (18), air builds up at the transition point. As discussed earlier, airflow within the larger bore slows down as a result, due to the smaller bore acting essentially as a flow restrictor. When the end of the fibre unit reaches this region within the conduit, there is insufficient viscous drag to carry the fibre unit into the transition point or smaller bore, or else it fails to enter effectively. The result is a fibre buckle. It should be noted that it is possible for the fibre unit to buckle anywhere along its length in the tube, not just at the fibre unit end.

By using the connector of the invention however, excess air building up around the transition point is vented from the connector bore (10) via the vent (13) and the housing aperture (14), to the surrounding environment. With the reduction of air in the connector bore, the air pressures are reduced at the transition point and the airflow in the larger tube improved. Thus the air is able to flow across the transition point and into the smaller connector bore (10b) at a velocity sufficient to generate viscous drag. This means that the fibre unit is more likely to be able to pass through the transition point.

The vent (13) in the embodiment shown in FIG. 2 is configured to extend outwardly from the connector bore at a direction against, and at an angle obtuse to, the air flow (arrow “X”). This particular arrangement of the frustum structures (20, 22) making up the vent discourages the fibre unit travelling in the direction of the air flow (arrow “X”) from accidentally being vented with the excess air. It also allows for the surplus air to be evenly vented, so that air flow out of the connector will not buffet the fibre unit as it travels through the transition point. However the skilled person would realise that it would be within the scope of the invention to configure the vent in any other manner or direction—for example, it could comprise one or more bores or channels leading from the connector bore out to the surrounding environment, or be angled in any, or multiple, directions.

Another advantage of the particular configuration at the transition point is that in installation through dissimilar bores connectorised by conventional reducer or straight connectors, the end of the fibre unit leaving the larger bore could get caught on the lip of the smaller bore at the transition point. In the present connector, the transition point is configured so that the fibre has nothing to catch on as it travels from the larger bore to the smaller bore.

This connector (2) is intended to be left in place after the installation of the blown fibre is completed. It will thereafter serve a function as a conventional reducer or straight connector within the network, and will be sealed or capped against water and/or gas as the case may be. Such a “one-use” connector can be manufactured from cheap plastic materials in a cost-efficient manner (e.g. by moulding). Using this connector to obtain a single end-to-end blown fibre installation will significantly reduce operational and manpower costs associated with failed uni-directional installations, or bi-directional installations where at least one leg of the installation route is wastefully short.

In a preferred embodiment, the connector is configured to be coupleable to a device that controls the venting of air from the vent, or a hose or conduit leading to such a controlling device, such as an air pressure gauge for example, at the housing aperture (14). One of the most preferred implementations of the inventions involves the connection of a pressure maintaining gauge to the connector. By using this, an operator can simply set the gauge to the preferred or ideal pressure level (for example, those in Table 1 above, if applicable), which will vent the excess air in the connector to that level, and maintaining the level for the duration of the installation session.

FIG. 3 is an external view of the assembled connector described above in connection with FIG. 2. The two housing portions (4 and 6) are coupled together, and this view shows the smaller opening (8b) through which, in use, air and the fibre unit emerges in the direction of arrow “X”.

FIG. 4 is another external view of the connector discussed in connection with FIGS. 2 and 3 above, wherein the housing portions (4 and 6) have yet to be assembled together. This view shows the smaller connector bore (10b), as well as the male frustum structure (22) making up the annular vent. The female frustum (20,) is located within the smaller connector bore (10b) but not visible in the drawing.

The skilled person would however realise that the connector can be made as a unitary piece not requiring assembly.

A connector with an adjustable vent will now be discussed using the connector shown in FIG. 4 for illustration. In this connector, the vent (13) is formed from the assembly of the first housing portion (4) and the second housing portion (6). The width of the vent of the connector shown is not adjustable owing to the click-fit of the two housing portions (4, 6) when the coupling portion (11 in FIG. 2) engages with the shoulder (12).

In an adjustable embodiment, the width or extent of the vent could be adjusted by changing the distance between the two housing portions are from each other when they are coupled together. For example, providing a screw-fit between the housing portions will allow the width of the vent to be adjusted as required. Preferably, this embodiment should include some method of clamping the desired configuration together so that the width of the vent does not change when in use with pressurised air. Various alternatives will occur to the skilled person: for example, the snap-fit connection could comprise a number of pre-defined positions from which an operator can select to adjust the vent width. Further, the vent need not be formed from the engagement of the two housing portions, but instead be a simple aperture controlled by means integral to the connector (e.g. with a mouth which can be slid open and shut), or by means external to the connector.

### Smaller-Tube to Larger-Tube Blown Fibre Installation

In an application where air is fed initially into the tube with the smaller bore with the intention that it flow into a tube with a larger bore, the problem is reversed. Where air is to flow from a smaller bore with a lower CSA into a bore with a higher CSA, there is no pressure build up at the transition point, so the air flows unimpeded into the connector. However, when the smaller mass of air within the smaller tube passes the transition point and into the larger tube, pressure levels drop and the volume of air which filled the small bore is “lost” in the larger bore. Consequently air velocity drops, and viscous drag effect on the fibre unit skin diminishes until the installation stalls. The problem thus is an insufficiency of air within the large tube.

Referring to the pressure gradient graph in FIG. 2B, it can be seen that the profile for a small-to-large bore installation is the opposite to that for a large-to-small bore installation.

When air is initially fed into the small bore at the head end, the pressure level drops relatively rapidly—more rapidly than in a similar length of larger bored tube—and then at and after the transition point (represented by point “B” on the graph) the pressure level drops significantly and the gradient thereafter becomes less steep as the air eventually vents at the remote end to atmospheric levels.

FIG. 5 is shows how the connector of FIG. 2 which was used for a large bore to small bore installation, can also be used for an installation the opposite way round. In this case, the air is fed in the direction of arrow “Y” from the small tube (T2) to the large tube (T1). In order to obtain a smooth flow of air through the transition point, air is added at or proximate to the transition point. By using the aperture in the connector, an air source in the form of e.g. a compressor can be connected to the conduit at the point where the additional air is needed.

Once again, the connector described above is useful to attain the aim of the invention, but it is not essential to use this embodiment of the connector. For example, the air could be added by a compressor connected to a simple T-piece or a conventional closedown assembly, which perform the task of connecting the two sections of tube together. The air can be added at the transition point, or into the larger tube directly.

The air can be added in a way which requires the operator to monitor the transition point until he is satisfied that air is flowing into the large tube at a velocity that would support viscous drag along the skin of the fibre unit to continue along the larger tube. As would be the case for a large-to-small blown fibre installation where air is vented, however, requiring the operator to monitor the change of air pressure, flow and velocity within the conduit until an optimal state is reached, requires the operator to have some experience and a “feel” for when to shut off the vent or aperture. Preferably the installation process should be deskilled to require less expertise of the operator. Thus in the present case, the air can be added in a controlled manner by using various apparatus.

One of the most preferred methods is to use a pressure maintaining valve as discussed above in connection with large-to-small installation, wherein the operator could simply set the apparatus so that the ideal pressure level (discussed above in connection with large-to-small bore installation, examples of such values being those in Table 1) is attained and maintained. Alternatively, a controlling device, such as a pressure gauge or flow meter can be used, as in the case for large-to-small blowing. A relatively inexperienced operator would be able to calculate the desired pressure values, or else look up the correct air pressure levels, to correctly set such devices. The table of values prepared for the large-to-small blowing sessions would be valid for use used in small-to-large installation sessions as well.

While the procedures involved to equalise air flow and pressures across the transition point are different depending on the direction of installation, the connector of FIG. 2 or FIG. 5 can be adapted to perform both functions. Essentially, such an adapter would comprise a vent or aperture allowing for air to be removed, or added as needed. Using such a connector would give the operator more flexibility in deciding where the start point will be: from the large bore tube end, or the small tube end. Another advantage of such a connector allows for a number of connectors to be used when connecting a series of tubes having dissimilar bores, although of course connectors dedicated to only one function, either venting or adding air, could be used as necessary.

FIG. 6 is a schematic view of a connector (2) which can be used for venting or adding is depicted. This embodiment of the invention comprises a unitary body requiring no assembly, and includes a tapering bore (10) similar to the prior art reducer connector depicted in FIG. 1. The large tube (T1) and the small tube (T2) are fitted to the ends of the connector, and air can flow in one direction (arrow “X”) or the other (arrow “Y”). A vent (13) allows the bore (10) to communicate with the atmosphere via housing aperture (14), allowing for air to be added or vented (arrow “Z”) as the case may require. This connector is dimensioned somewhat differently from the connector of FIG. 2 or FIG. 5, as the larger bore (10a) portion has the same internal dimension as the larger tube, is uniform and relatively long. It then tapers to the internal dimension of the smaller bore, as shown.

This design recognises that the excess or insufficiency of air (as the case may be) leading to a drop in air speeds and thus viscous drag within the conduit, is located within the larger tube section proximate to the transition point or region (18). In a large-to-small installation, the pressure build up at the transition point is ideal for feeding air into the small tube, but such build up stalls air flow in the larger tube. In a small-to-large installation, an increased CSA at the transition point is ideal to encourage airflow in the small tube, but the limited mass of air from the small tube entering the big tube is insufficient to sustain air velocities for viscous drag.

As noted above, the venting or addition of air can be performed at a position not only at, but also proximate to the transition point. In this embodiment, the vent (13) is located effectively within the larger bore (as the larger bore section of the connector is effectively an extension of the larger tube itself). This configuration of the connector mitigates the effect that venting or adding at the transition point would have on the smaller bore.

Yet other variations are possible within the scope of the invention: in a large-to-small installation a connector (2) as shown in FIG. 7 could include two differently-sized bore sections to accommodate the two tubes (T1, T2), the bores interfacing at transition point (18). A first aperture (13) is provided in the larger bore (10a) which allows air to be vented, and a second aperture (15) is provided in the smaller bore (10b) allowing for air to be added. Thus, the aperture or vent need not be provided at the transition point (18) to encourage the air in the large tube (T1) to flow into the connector, while at the same time air added at a point proximate to the inlet end of the smaller tube (T2) would provide sufficient air pressure to encourage air to enter the small tube.

If the apertures for venting and adding air are correctly placed along the conduit, there is a further advantage of there being no need to control the venting or adding processes using pressure maintaining means or the like, i.e. there is no need to ensure the existence of a particular pressure level at the transition point or any other area along the conduit to obtain a smooth and optimal flow of air across the transition point.

The apparatus, methods and configurations described above and in the drawings are for ease of description only and not meant to restrict the invention to any particular embodiments. It will be apparent to the skilled person that various sequences and permutations on the apparatus and methods described are possible within the scope of this invention as disclosed.

1.-30. (canceled)

31. A method of installing a cable into a conduit using a flow of air, the conduit comprising a first tube having an outlet end and having a first bore size, and a second tube having an inlet end and having a second bore size, the method comprising
connecting the outlet end and the inlet end to form a bore size transition point,
mechanically driving the cable into the first tube towards the outlet end,
introducing air into the first tube to flow to the outlet end so that the cable is transported through the first tube and into the second tube by a combination of the effects of the mechanical driving and the flowing air, and
changing a transition air pressure level of the air at from a first pressure level to a second pressure level by either venting a part of the air from the conduit or near the transition point, or adding air into the conduit or near the transition point.

32. A method according to claim 31 further including a step of maintaining the second pressure level.

33. A method according to claim 31 further including the step of providing an aperture in the conduit at or near the transition point, and wherein the step of changing the air pressure is performed using the aperture.

34. A method according to claim 31 wherein the first bore size of the conduit is larger than the second bore size, and wherein the step of changing the air pressure level comprises reducing the pressure level of the air within the conduit by venting a part of the air from the conduit.

35. A method according to claim 31 wherein the first bore size of the conduit is smaller than the second bore size, and wherein the step of changing the air pressure level comprises increasing the pressure level of the air within the conduit by adding air into the conduit.

36. A method according to claim 31 wherein the step of changing the air pressure is performed using any one of an air pressure maintaining gauge, an air pressure valve, or a flow meter.

37. A method according to claim 32 wherein the step of maintaining the second pressure level is performed using any one of an air pressure maintaining gauge, an air pressure valve, or a flow meter.

38. A method according to claim 31 further including a step of pre-determining the transition air pressure level.

39. A connector for installing a cable into a conduit, the conduit comprising a first tube having a first bore size, connected by the connector to a second tube having a second bore size, wherein the first bore size differs from the second bore size, and wherein in use, air is introduced into the first tube to flow through the first tube to the second tube via the connector,
the connector comprising
connection means to form the conduit by connecting the bore of the first tube to the bore of the second tube in a series via the connector, and means to change an air pressure of the air within the conduit from a first pressure level to a second pressure level by either venting a part of the air from the conduit or adding to the air within the conduit.

40. A connector according to claim 39 further including means for maintaining the second pressure level.

41. A connector according to claim 39 wherein the connector includes a housing and wherein the means to change the air pressure comprises an aperture in the housing.

42. A connector according to claim 41 wherein the aperture is adapted for one or both of venting or adding of air to the conduit.

43. A connector according to claim 39, further adapted to be used with control means to control the change of the air pressure.

44. A connector according to claim 43 wherein the control means is any one of an air pressure maintaining gauge, an air pressure valve, or a flow meter.
